(19) United States
(12) Patent Application Publication
(10) Pub. No.: US 2012/0005407 A1
(43) Pub. Date: Jan. 5, 2012

(54) REVOLVING DATA MANAGEMENT METHOD

(75) Inventors: Gregory Fazilleau, Vendome (FR); Didier Guinier, Notre Dame d'Oe (FR)

(73) Assignee: THALES, NEUILLY SUR SEINE (FR)

(21) Appl. No.: 12/974,464

(22) Filed: Dec. 21, 2010

(30) Foreign Application Priority Data
Dec. 23, 2009 (FR) FR0906271

(51) Int. Cl. G06F 12/00

(52) U.S. Cl. 711/103; 711/E12.008

(57) ABSTRACT

The invention relates to a method of managing data to be written several times into a memory organized in sectors, each sector requiring complete erasure to allow a new write operation in the sector. To manage the data in a revolving manner, the method includes: ordering the sectors of the memory, the sector ordering taking place in a revolving manner, the sector following the last sector being the first sector; reserving, for each sector, a header zone intended to receive a first word that defines the filling of the sector; defining, in each sector, locations each intended to receive a data item; and associating part of the header zone with each data location, the part of the header zone written when a data item is stored in the corresponding data location.

### CROSS-REFERENCE TO RELATED APPLICATION

This application claims priority to foreign French patent application No. FR 09 06271, filed on Dec. 23, 2009, the disclosure of which is incorporated by reference in its entirety.

### FIELD OF THE INVENTION

The invention relates to a method of managing data to be written several times into a memory organized in sectors, each requiring complete erasure of old writing in order to allow a new write operation in the sector.

### BACKGROUND OF THE INVENTION

Fast programmable read-only memories, known by the name “FlashPROM”, are used. FlashPROM memories are particularly well suited: they are very fast read-only memories allowing the storage of a large volume of information in a small area. These memories consume little power. This type of memory is organized in sectors, also called pages, and, during operation, it is possible to erase the stored information only by erasing at least one entire sector. It is not possible to erase just part of a sector. FlashPROM memories are not suited to the storage of data intended to be modified during operation when these data are of a size smaller than the size of a sector. It is easy to obtain FlashPROM memories having a sector size of between 1 and several tens of kilobytes. It may therefore be understood that this type of memory is not suitable for data of a few bytes intended to be modified.

The invention is concerned with data having a low read, write and erase occurrence. As an example, mention may be made of logs of faults arising in an electronic system. These fault logs may be stored in a revolving manner. More precisely, the latest data items replace the oldest data items. Thus, a log recording a defined number of events is maintained, this number being determined by the size of the memory allocated to these data items. Data management of this type is often called revolving table management.

For such data, it is possible to use electrically erasable read-only memories well known in the literature by the name “EEPROM”. These are read-only memories allowing the storage, erasure and rewriting of individual data items of variable sizes. For data management in revolving table form, a simple pointer defining the location of the latest data writing is used to determine the location into which the next data has to be written. These memories are well suited to managing revolving tables, however, compared with FlashPROM memories, EEPROM memories are not as fast, have smaller storage capacity and consume more power.

### SUMMARY OF THE INVENTION

The invention allows a revolving table to be managed in a FlashPROM or equivalent memory for data having a size smaller than that of a sector.

The invention provides a method of managing data to be written in revolving form into a memory organized in sectors, each requiring complete erasure in order to allow a new write operation in the sector, the latest data replacing the oldest data, each sector being able to contain several data items, the method including:
in ordering the sectors of the memory, the sector ordering taking place in a revolving manner, the sector following the last sector being the first sector;
in reserving, for each sector, a header zone intended to receive a first word that defines the filling of the sector;
in defining, in each sector, locations each intended to receive a data item; and
in associating part of the header zone with each data location,
   where the part of the header zone being intended to be written when a data item is stored in the corresponding data location.

The invention is well suited to data management in a FlashPROM memory organized in pages, in which only one page may be erased, for example. It is also possible to regroup several pages of the memory in order to form a sector according to the invention. In this case, only a single header zone is provided for a sector formed from a group of several pages.

The invention also provides a procedure for erasing the oldest data. This is because, for this type of memory, an erasure sequence typically lasts several seconds, during which operating incidents may occur. For example, a cut in power to the memory during the erasing sequence may interrupt the sequence.

In the invention, it is possible to dispense with an EEPROM memory, by storing the data that it contains in another type of memory, for example one already partially used for storing the program for operating an electronic system. Consequently, the invention makes it possible to reduce the number of components present in the electronic system and to reduce its power consumption.

### BRIEF DESCRIPTION OF THE DRAWINGS

The invention will be better understood and other aspects, features and advantages will become more readily apparent from the following detailed description of one or more embodiments given by way of example, this description being illustrated by the appended drawing, in which:

FIG. 1 shows schematically an example of memory structuring, in which the memory is cut into zones and into sectors; and

FIG. 2 shows schematically the structure of one particular sector; and

FIG. 3 shows schematically the structure of one particular zone.

For the sake of clarity, identical elements will have the same references in the various figures.

### DETAILED DESCRIPTION

The invention will be described in relation to a memory with which an electronic apparatus on board an aircraft is equipped. This type of memory may for example be used for chronologically storing incidents occurring in the apparatus.

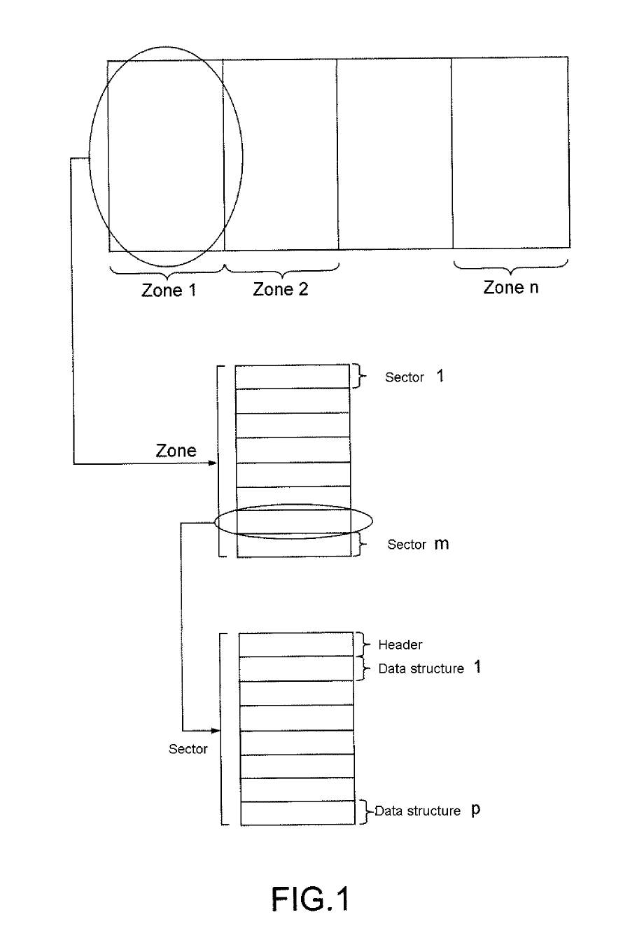

FIG. 1 shows a memory advantageously cut into several zones, denoted Zone 1, Zone 2 up to Zone n each containing several sectors, namely Sector 1 to Sector m. Each sector is designed to store several data items that may be written separately. It is possible to dedicate the zones for different uses. For example, one zone may be used to store operating contexts of the apparatus and another zone for storing incidents. Each sector requires complete erasure of old writing in order to allow new writing into this sector.

Advantageously, in each sector the various locations, denoted Data structure 1 to Data structure p, which are provided for storing the data, all have the same size and are designed to receive any data whatsoever coming from the apparatus, for example context data or incident data depending on the zone in question. The zones are independent and the defined sizes of the data locations may differ from one zone to another.

A header zone is reserved in each sector. The header zone may have the same size as that of the data structures of the sector in question. The header size may be larger and it is possible to choose as header size a multiple of the size of a data structure of the zone in question.

The sectors in a zone are ordered. A rank, namely 1 to m in FIG. 1, is assigned to the sectors of a zone. The ordering is revolving, in other words, the sector following the last sector m is the first sector 1.

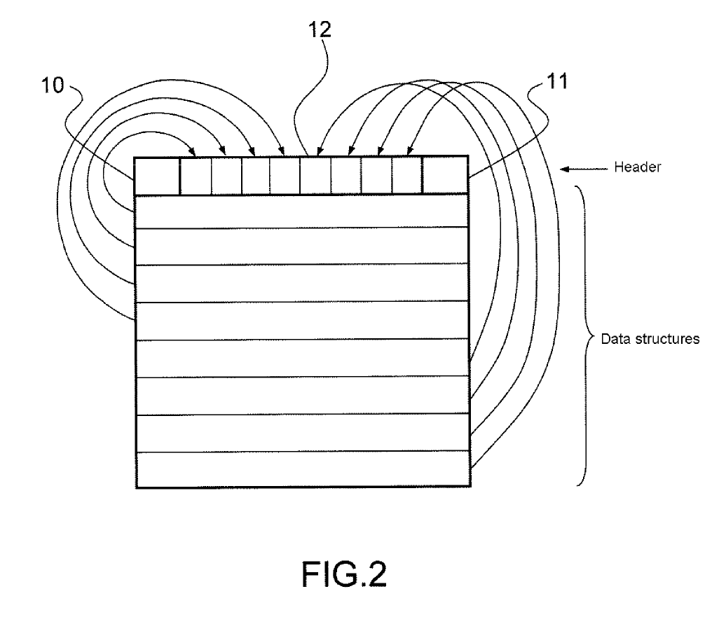

FIG. 2 shows schematically the structure of one particular sector, more particularly the structure of the header of this sector.

The header zone comprises a first location 10 intended to receive a word that indicates that the last erasure of the sector was carried out correctly and a second location 11 intended to receive a second word that indicates that an erasure procedure for the preceding sector in the order defined for the zone is in process. The word of the first location 10 advantageously serves as sector start indicator.

More precisely, to erase a given sector i, a method according to the invention includes performing, e.g., concatenating, the following operations:
writing, into the location 11 of the sector following the given sector, that is to say into the location 11 of the sector i+1, the word specifying that the erasure procedure has started,
erasing the sector i; and
writing, into the location 10 of the sector i, the word indicating that the last erasure of the sector was correctly carried out.

When a sector of a FlashPROM memory is erased, all the bits of the sector have a logic state 1. It is possible to modify the logic state of a single bit in order to bring it to zero. Thus, a writing sequence in the memory may therefore be carried out bit by bit. In contrast, the switching from a logic state 0 to a logic state 1 can take place only globally for the entire sector. This corresponds to a memory erasure sequence. For the word written into the location 10 indicating that the last erasure of the sector was carried out correctly and for the word written into the location 11 specifying that the erasure procedure has started, words will be chosen that are different from a word comprising only bits in logic state 1, the logic state immediately following an erasing sequence for a FlashPROM memory. It will also be advantageous to choose words not belonging to the set of words used for the data.

It is possible to encode the word written into the location 11 over two bits. A “1,1” value of a word in the sector i+1 corresponds to the state of the word before the start of the procedure for erasing the sector i. A “1,0” value corresponds to the state of the word at the start of the procedure for erasing the sector i. If an incident appears during the procedure for erasing the sector i, for example a loss of power for the memory, then the “1,0” value will be found at the location 11 of the sector i+1 and not the word indicating that the last erasure of the sector was correctly carried out at the location 10 of the sector i.

By reading from the location 10 of the sector i it will be possible to check whether or not the erasure procedure has been correctly performed for the sector i. The presence, at the location 10, of the word indicating that the last erasure of the sector was carried out correctly ensures that the erasure procedure was correctly performed.

When the location 10 serves as sector start indicator, the erasure of the sector starts with this location. For a FlashPROM memory, the erasure procedure starts with the location 10 and lasts several seconds. In the event of the erasure procedure being interrupted, the word in the location 10 will be almost certainly erased and by reading it a problem that has occurred during the erasure procedure may be detected.

If the erasure procedure has not been carried out to completion, it is conceivable to repeat it. To avoid too many successive repetitions of the erasure procedure, it is possible for example to envisage repeating the procedure only if this has been interrupted by a loss of power for the memory. Another possible condition is to limit the number of repetitions to a given value, for example a single repetition.

If reading from the location 10 does not give the word indicating that the last erasure of the sector was carried out correctly, even after a possible repetition, the sector i is declared invalid. To store this declaration of invalidity, it is possible to use the location 11 in the sector i+1 by writing the “0,0” value thereinto. By using, for the declaration of invalidity of the current sector i, another sector, in this case the sector i+1, it is possible no longer to consider the sector declared invalid and thus not to run the risk of an interpretation error when reading from the invalid sector.

Advantageously, in order to avoid rereading, several times, the word written into the location 10 in a sector declared invalid, it is possible to omit this sector in the ordering of the sectors of the memory. The reordering of the memory takes place during the erasure of the sector i+1 so as to reset the location 11 to the “1,1” value.

A zone of the memory contains several sectors, for example eight sectors. A predefined threshold of the number of sectors declared invalid may be set. If the number of invalid sectors exceeds the predefined threshold, the memory is declared invalid. It is also possible to specify this threshold for each zone of the memory and verify the threshold violation for each zone of the memory. If within a zone of the memory the predefined threshold is exceeded, only this zone is declared invalid. The other zones can therefore still be used.

The header zone of each sector comprises, moreover, a third location 12 intended to receive a word indicating the filling of the sector.

Locations each intended to receive a data item in each sector are defined and a part of the location 12 of the header zone is associated with each data location. The part of the header zone is intended to be written when a data item is stored in the corresponding location. One bit is sufficient for each part. In other words, one bit in the location 12 is associated with each data location. To manage a revolving table, the data items are written chronologically. The data locations are also ordered in a sector. It is therefore easy to associate the bits in the location 12 with the data locations in the same order. This ordered association is shown symbolically in FIG. 2 by the curvilinear arrows.

After a sector has been erased, all the bits in this sector, and in particular those in the location 12, are in logic state 1. When the procedure for writing a data item into a data location is carried out, a “0” value is written into the corresponding bit in the location 12. It is important not to separate these two writings in the data location and in the location 12 so as to enable the filling of the sector to be subsequently tracked by a simple reading from the location 12.

If the bits in the location 12 are in the same order as the order in which the data is written, then the bits in the location 12 switch, one after another, from the logic state 1 to the logic state 0 while the sector is being filled. To determine the next data location into which data will be written, it is sufficient to read in order the bits in the location 12. The first bit, the logic state of which is 1, corresponds to the first free data location.

By chronologically reading the bits of the location 12 in a given sector, it is possible to determine the degree of filling of the sector in question. Since the sectors are ordered, by successively reading, in the order of the sectors, the filling words stored in the various locations 12, the first incomplete sector and the first available data location, in this sector, are determined.

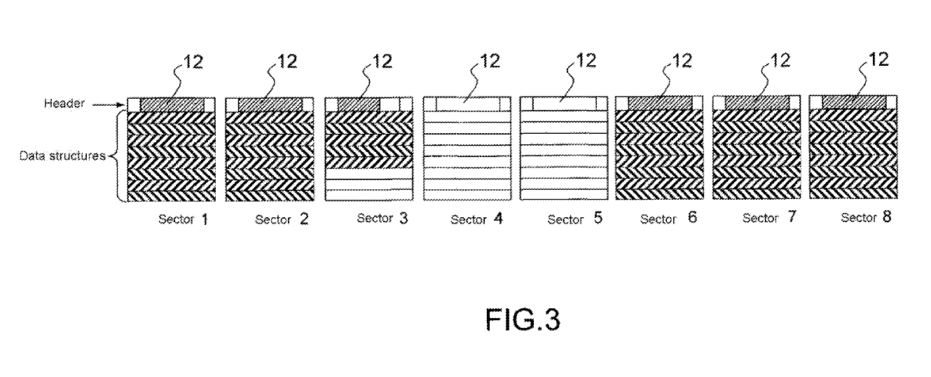

FIG. 3 shows schematically the structure of one particular zone of the memory. FIG. 3 serves to illustrate the erasure of the oldest data so as to ensure that the memory operates in the form of a revolving table. The zone shown in FIG. 3 comprises eight sectors, each comprising a header and eight data locations denoted “data structure”. Of course, the number of sectors and the number of data locations have been given merely by way of example. Hatching in the data locations symbolize locations occupied by data and, conversely, unhatched data locations symbolize free data locations. In the example shown, sectors 1, 2, 6, 7 and 8 are completely occupied by data and sectors 4 and 5 are completely free. The first five data locations in sector 3 are occupied and the last three data locations in sector 3 are free. The locations 12 in each sector have been shown shaded, to represent the filling of the corresponding sectors.

The number of sectors that have to remain completely free, for example two, is predefined. For the entire memory, or for a zone of the memory if the memory is cut into zones, the words defining the filling of the various sectors in the locations 12 are read so as to determine the number of sectors in which all the data locations are free. If the number of sectors in which all the data locations are free is greater than or equal to 2, then the data may continue to be stored in the sector during the filling operation, here in sector 3. If on the contrary the number of sectors in which all the data locations are free is less than the predefined number, 2 in the example, then the sector containing the oldest stored data is erased. In the example shown, this condition will be fulfilled upon writing a data item into the first data location of the sector 4. Since the filling of the sectors takes place in the order of the sectors, the oldest data items are stored in sector 6. To determine this sector, it is possible for example, when reading the filling words stored in the various locations 12, to seek the first word having its bits in the “0” state that follows a word having its bits in the “1” state. When this sector has been determined, the erasing sequence for this sector may be started.

When it is detected that an erasing sequence is necessary and that a data item has to be written, the procedure starts by writing the data. The oldest sector is then erased. During the erasure, the status of the memory takes what is called an “occupied” value, thereby preventing any other use of the memory, notably preventing new data from being written. If during the erasure procedure data items are presented for being written, provision may be made for storing them temporarily, for example in a volatile memory, until the erasure procedure has been completed. Once the erasure procedure has been completed, the status of the memory takes what is called a “free” value and the writing of the data may take place as indicated previously.

1. A method of managing data to be written in revolving form into a memory organized in sectors, each sector requiring complete erasure to allow a new write operation in the sector, the latest data replacing the oldest data, each sector being able to contain several data items, the method comprising:
ordering the sectors of the memory, the sector ordering taking place in a revolving manner, the sector following the last sector being the first sector;
reserving, for each sector, a header zone to receive a first word that defines the filling of the sector;
defining, in each sector, locations each to receive a data item;
associating part of the header zone with each data location, wherein the part of the header zone to be written when a data item is stored in the corresponding data location;
successively reading, in the order of the sectors, the words that define the filling of each sector;
determining the first incomplete sector and, in this sector, the first available data location;
writing a data item into the first available data location; and
writing, into the part of the header zone associated with the first available data location, a value indicating that the data location is occupied.

2. The method according to claim 1, wherein
the parts of the header zone associated with the data locations each occupy one bit,
the value of the bit after erasure is associated with the corresponding data location being free, and
the inverse value of the bit is associated with the corresponding data location being occupied.

3. The method according to claim 1, further comprising:
reading, for the entire memory, the words that define the filling of the various sectors to determine a number of sectors in which all the data locations are free; and
if said number of sectors is less than a predefined number, erasing the sector containing the oldest stored data items.

4. The method according to claim 1, wherein the header zone of each sector receives a second word indicating that the latest erasure of the sector was carried out correctly and a third word indicating that an erasure procedure for the preceding sector is in process.

5. The method according to claim 4, wherein the second word is a sector start indicator.

6. The method according to claim 4, further comprising, to erase a given sector, performing the following operations:
writing, into the sector following the given sector, the third word;
erasing the given sector; and
writing, into the given sector, the second word.

7. The method according to claim 6, wherein, if after a procedure of erasing a sector, when reading from the first location of this sector, the first word is not found, then the erasure procedure is repeated.

8. The method according to claim 6, further comprising, for writing data items different from the header into a given sector, verifying the exactitude of the second word before writing the data items, and if the second word of the given sector is not exact, declaring the sector invalid, wherein a declaration of invalidity of the given sector is made in the following sector.

9. The method according to claim 8, wherein the declaration of invalidity of the given sector is made at the location of the third word.

10. The method according to claim 8, wherein a sector declared invalid is omitted in the ordering of the sectors of the memory.

11. The method according to claim 8, further comprising:
counting the number of invalid sectors; and
if the number of invalid sectors exceeds a predefined threshold, declaring the memory invalid.

12. The method according to claim 8, further comprising:
cutting the memory into several zones each containing several sectors; and
for each of the zones of the memory, if the number of invalid sectors exceeds a predefined threshold, declaring the zone of the memory invalid.
